(19) United States
(12) Patent Application Publication
(10) Pub. No.: US 2008/0192108 A1
(43) Pub. Date: Aug. 14, 2008

(54) Call Setup Method Between a Calling Terminal and a Called Terminal

(75) Inventors: Marc Pelous, Paris (FR); Jean-Chritophe Le Gall, Treillieres (FR)

Correspondence Address: SUGHRUE MION, PLLC, 2100 PENNSYLVANIA AVENUE, N.W., SUITE 800, WASHINGTON, DC, 20037, US

(73) Assignee: Alcatel Lucent, Paris (FR)

(21) Appl. No.: 11/995,626

(22) PCT Filed: Oct. 13, 2005
(86) PCT No.: PCT/FR2005/050849

§ 371 Date: Feb. 8, 2008

(30) Foreign Application Priority Data
Jul. 13, 2005 (FR) 0552176

(51) Int. Cl. H04N 7/14

(52) U.S. Cl. 348/14.01

(57) ABSTRACT

The invention relates to methods for establishing a video call between calling (UEA) and called (UEB) terminals through a telecommunications network comprising a service node (SN) for providing a video application. The inventive method comprises the following stages: a stage for requesting to establish a call between the calling and called terminals, an alarm stage indicating that the called terminal is alerted, a connection stage indicating that the called terminal is picked up, a trading stage for establishing logical video and audio channels between the calling terminal and the service node, wherein the beginning of the trading stage between the calling terminal and the service node is situated after the beginning of the alarm stage and before the beginning of the connection stage.

The invention relates to the field of call setup methods between a calling terminal and a called terminal. After a successful setup phase, these methods require an end-to-end negotiation, handled by the terminals and not by the intermediate nodes. The invention relates more particularly to the field of video calls. In the telecommunication network to which the calling and called terminals belong, there is a service node capable of providing a video application when a video call is set up. To enable this video application to be provided, a connection and video and audio logical channels must be set up between the calling terminal and the service node. The video application is preferably a ringback tone with video function.

Conventionally, the negotiating of the setting up of the video and audio logical channels between the calling terminal and the service node begins once the connection is set up between the terminals. However, this conventional procedure presents two drawbacks in particular. On the one hand, the waiting time preceding the provision of the video application by the service node is relatively long. On the other hand, the time it takes for the logical channels to be set up is charged to the users since this setting up is performed after the connection has been set up between the users' terminals.

There would therefore be an interest in being able to set up the logical channels, or at least be able to start to set up the logical channels, before the connection between the users' terminals is itself set up. No new message, compared to the existing conventional procedure, is needed. However, the behavior of the calling terminal, of the service node, and of the called terminal in a particular embodiment, needs to be adapted in as much as, instead of waiting for the connection to be set up, the calling terminal and the service node need to begin negotiating the setting up of the logical channels before the connection between the calling terminal and the called terminal is set up.

For this, the invention proposes beginning the negotiating of the setting up of the logical channels between the calling terminal and the service node once the called terminal has been alerted. Thus, the ability of the called terminal to support a video call can be checked. Otherwise, the calling terminal will be billed at the video call tariff over the part of the link located between the calling terminal and the service node for the duration of the call although between the calling terminal and the called terminal, the call will only be an audio call. To be billed, for part of the link, at the video call tariff for an audio call, is something that the user of the calling terminal cannot accept.

The invention relates to a method of setting up a video call between a calling terminal and a called terminal. The invention also relates to a type of calling terminal specially suited to implementing the method of setting up a video call according to the invention and a type of service node specially suited to implementing the method of setting up a video call according to the invention.

According to the invention, there is provided a method of setting up a video call between a calling terminal (UEA) and a called terminal (UEB), via a telecommunication network comprising a service node (SN) capable of providing a video application, comprising: a call setup request step between the calling terminal and the called terminal; an alert step indicating that the called terminal has been alerted; a connection step indicating that the called terminal has answered; a step for negotiating the setting up of video and audio logical channels between the calling terminal and the service node; characterized in that the start of the negotiation step between the calling terminal and the service node is situated after the start of the alert step and before the start of the connection step. Preferably, the start of the negotiation step is situated after the end of the alert step. Preferably, the method of setting up a video call between a calling terminal and a called terminal according to the invention also comprises a step for negotiating the setting up of video and audio logical channels between the called terminal and the service node.

According to the invention, there is also provided a calling terminal able: to transmit a call setup request message (SETUP); to receive an alert message (ALERTING) indicating that a called terminal has been alerted; to receive a connection message (CONNECT) indicating that a called terminal has answered; to negotiate with a service node capable of providing a video application on the one hand with the setting up of a signaling channel and on the other hand with the setting up of a multiplexing for the signaling channel and video and audio logical channels; characterized in that said calling terminal comprises means for starting to negotiate after having received the alert message but before receiving the connection message.

According to the invention, there is also provided a service node able: to transmit a message (IAM), the function of which is to transmit a call setup request message (SETUP) on behalf of a calling terminal; to transmit a message (ACM), the function of which is to transmit an alert message (ALERTING) indicating that said called terminal has been alerted; to transmit a message (ANM), the function of which is to transmit a connection message (CONNECT) indicating that said called terminal has answered; to negotiate with a calling terminal on the one hand on the setting up of a signaling channel and on the other hand on the setting up of a multiplexing for the signaling channel and video and audio logical channels; characterized in that said service node comprises means for starting to negotiate after having transmitted the alert message before having transmitted the connection message.

The invention will be better understood, and other features and advantages will become apparent, from the description below and the appended drawings, given by way of examples, in which:

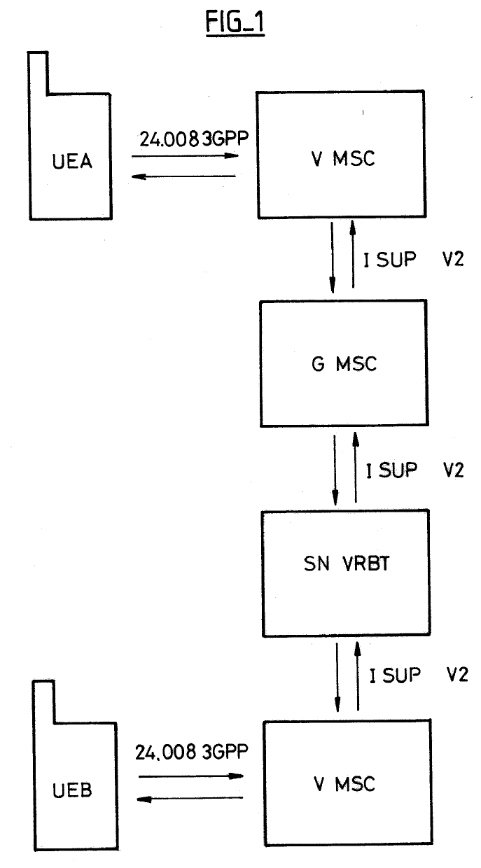

FIG. 1 diagrammatically represents an exemplary system comprising a calling terminal, a called terminal, a service node, and a part of the telecommunication network via which the terminals and the service node can intercommunicate;

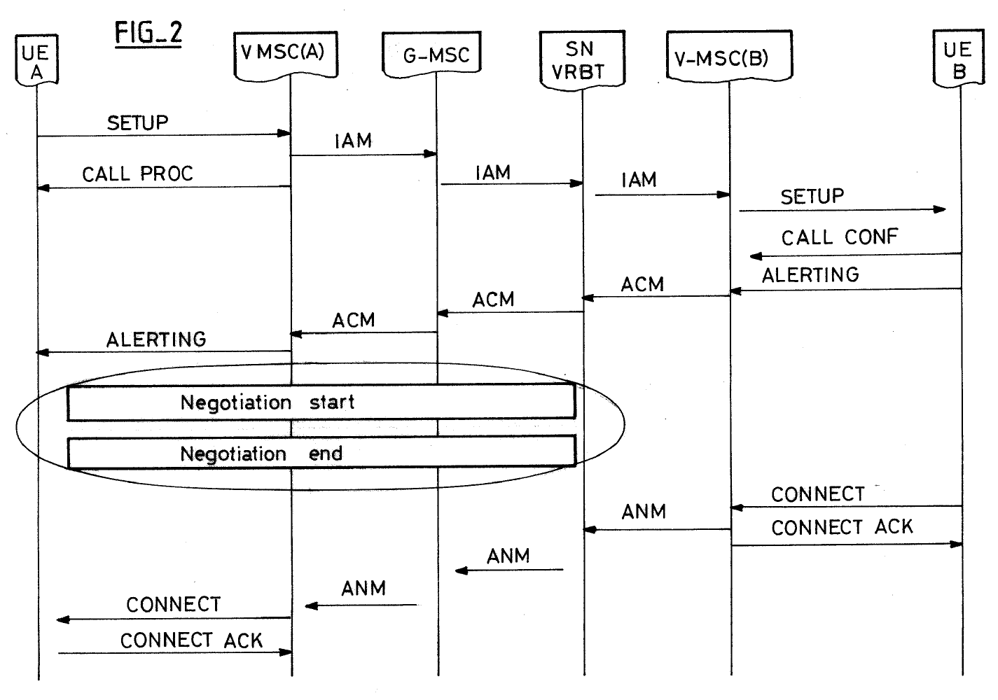

FIG. 2 diagrammatically represents an exemplary method of setting up a video call according to the invention.

FIG. 1 diagrammatically represents an exemplary system comprising a calling terminal, a called terminal, a service node, and a part of the telecommunication network via which the terminals can intercommunicate. The telecommunication network comprises a gateway switch of the GMSC (Gateway Mobile Switching Center) type, hereinafter denoted gateway switch GMSC, local switches of the VMSC (Visited Mobile Switching Center) type, hereinafter denoted local switches VMSC, terminals including a calling terminal denoted UEA and a called terminal denoted UEB, a service node SN VRBT (for service node video ringback tone), because the service node which is capable of providing the calling terminal with a video application is preferably capable of providing the calling terminal with a ringback tone with video function. One of the local switches VMSC is linked to the calling terminal UEA whereas the other local switch VMSC is linked to the called terminal UEB. The bidirectional signaling between a terminal and a local switch VMSC conforms to the 3GPP standard 24.008. The bidirectional signaling between a gateway switch GMSC and a local switch VMSC conforms to the ISUP V2 standard, as do the bidirectional signalings on the one hand between the service node SN VRBT and the gateway switch GMSC and on the other hand between the service node SN VRBT and the local switch VMSC.

Preferably, the telecommunication network is a circuit network, that is of circuit type, in which, for example, the ITU H.324 protocol is used for the video communications between users, and not a packet network, that is of packet type, in which the ITU H.323 protocol is, for example, used for the video communications between users. Advantageously, the telecommunication network is at least of the third generation, that is, it is a third generation or subsequent generation network.

Preferably, in the method of setting up a video call between a calling terminal and a called terminal according to the invention, the call setup request step extends between the transmission, by the calling terminal, of a call setup request message, and the reception, by the called terminal, of a call setup request message, the alert step extends between the transmission, by the called terminal, of an alert message indicating that the called terminal has been alerted, and the reception, by the calling terminal, of an alert message indicating that the called terminal has been alerted, the connection step extends between the transmission, by the called terminal, of a connection message indicating that the called terminal has answered, and the reception, by the calling terminal, of a connection message indicating that the called terminal has answered.

Preferably, in the method, according to the invention, of setting up a video call between a calling terminal and a called terminal, the negotiation step comprises on the one hand the setting up of a signaling channel and on the other hand the setting up of a multiplexing for the signaling channel and the video and audio logical channels. This negotiation step generally takes a few seconds, typically lasting around 5 to 10 seconds. Consequently, the time saved, on each communication between a calling terminal and a called terminal, by implementing the method according to the invention, is at most the duration of the negotiation step, but only a part of this duration if the user of the called terminal answers quickly, that is, before the end of the negotiation step.

FIG. 2 diagrammatically represents an exemplary method of setting up a video call according to the invention. The bidirectional signaling between a terminal and a local switch VMSC conforms to the 3GPP 24.008 standard. The bidirectional signaling between a gateway switch GMSC and a local switch VMSC conforms to the ISUP V2 standard. The bidirectional signaling between a gateway switch GMSC and a service node SN VRBT conforms to the ISUP V2 standard. The bidirectional signaling between a service node SN VRBT and a local switch VMSC conforms to the ISUP V2 standard. Preferably, the video communication between the terminals proceeds in accordance with the ITU H.324 protocol, here incorporated for reference, in conjunction with which FIG. 2 will be described and reference to which is made for the precise meaning and exact nomenclature of the messages. The method of setting up a video call between a calling terminal and a called terminal then conforms to the ITU H.324 protocol. The call setup request step is a SETUP step. The alert step is an ALERTING step. The connection step is a CONNECT step. The negotiation step conforms on the one hand to the ITU H.245 protocol for the setting up of a signaling channel and on the other hand to the ITU H.223 protocol for the setting up of a multiplexing for the signaling channel and the video and audio logical channels.

For the description of the various message interchanges, the local switch linked to the calling terminal UEA will be denoted local switch VMSC(A), whereas the local switch linked to the called terminal UEB will be denoted local switch VMSC(B). It is assumed that the communication medium is open between the terminals in both directions, that is, so as to allow a message transmission that is bidirectional, that is, from the calling terminal to the called terminal and from the called terminal to the calling terminal.

The calling terminal UEA sends to the local switch VMSC(A) a SETUP message by which it initiates the call setup request. The local switch VMSC(A) sends on the one hand to the calling terminal UEA a CALL PROC message by which it acknowledges reception of the request from the calling terminal and on the other hand to the gateway switch GMSC an IAM message by which it transmits the request from the calling terminal. The gateway switch GMSC sends to the service node SN VRBT an IAM message by which it transmits the request from the calling terminal. The service node SN VRBT sends to the local switch VMSC(B) an IAM message by which it transmits the request from the calling terminal. The local switch VMSC(B) sends to the called terminal UEB a SETUP message by which it transmits the request from the calling terminal.

The called terminal UEB sends to the local switch VMSC(B) on the one hand a CALL CONF message by which it acknowledges reception from the local switch VMSC(B) of the request from the calling terminal and on the other hand an ALERTING message to the calling terminal UEA by which the called terminal UEB signals that it has indeed been alerted by the request from the calling terminal. The local switch VMSC(B) sends to the service node SN VRBT an ACM message by which it transmits the alert from the called terminal. The service node SN VRBT sends to the gateway switch GMSC an ACM message by which it transmits the alert from the called terminal. The gateway switch GMSC sends to the local switch VMSC(A) an ACM message by which it transmits the alert from the called terminal. The local switch VMSC(A) sends to the calling terminal UEA an ALERTING message by which it transmits the alert from the called terminal.

The step for negotiating the logical channels between the terminals, which is performed in accordance with the ITU H.245 and ITU H.223 protocols, here incorporated for reference, begins, which is denoted by the “negotiation start” line. The end of this negotiation step is denoted by the “negotiation end” line. This negotiation is performed between, on the one hand, the calling terminal UEA and, on the other hand, the service node SN VRBT. After the end of the negotiation step, the service node SN VRBT provides the calling terminal with a video application, preferably a ringback tone with video function.

The called terminal UEB sends to the local switch VMSC(B) on the one hand a CONNECT message by which it signals to the local switch VMSC(B) that the user of the called terminal UEB has answered. The act of signaling that the user of the terminal UEB has answered will hereinafter be denoted by the signaling of the reaction of the called user. The local switch VMSC(B) sends on the one hand to the called terminal UEB a CONNECT ACK message by which it acknowledges reception of the signaling of the reaction of the called user and, on the other hand, to the service node SN VRBT an ANM message by which it transmits the signaling of the reaction of the called user. The service node SN VRBT sends to the gateway switch GMSC an ANM message by which it transmits the signaling of the reaction of the called user. The gateway switch GMSC sends to the local switch VMSC(A) an ANM message by which it transmits the signaling of the reaction of the called user. The local switch VMSC(A) sends to the calling terminal UEA a CONNECT message by which it transmits the signaling of the reaction of the called user. The calling terminal UEA sends to the local switch VMSC(A) a CONNECT ACK message by which it acknowledges reception of the signaling of the reaction of the called user.

The start of the step for negotiating the setting up of the logical channels between the calling terminal UEA and the service node SN VRBT, denoted “negotiation start”, is situated between, on the one hand, the sending, by the called terminal UEB, of the ALERTING message, more specifically, advantageously, the sending by the service node SN VRBT of the ACM message, the function of which is to transmit the ALERTING message sent by the called terminal UEB, and on the other hand, the sending, by the called terminal UEB, of the CONNECT message. The start of this negotiation step can be situated before or, preferably, after the reception, by the calling terminal UEA, of the ALERTING message. The end of this negotiation step, denoted “negotiation end”, can be situated before or after the sending, by the called terminal UEB, of the CONNECT message, depending on the speed of reaction of the called user, that is, depending on the moment when the user of the called terminal UEB answers.

On the calling terminal UEA side, the step for negotiating the setting up of the logical channels begins just after the reception of the ALERTING message. On the service node SN VRBT side, the step for negotiating the setting up of the logical channels begins, either just after the sending of the ACM message, or when the service node SN VRBT detects that the calling terminal has begun the step for negotiating the setting up of the logical channels and, for example, tries to set up the multiplexing. If the called user answers before the step for negotiating the setting up of the logical channels is completed, this step for negotiating the setting up of the logical channels continues normally as if the called user had not answered.

Another step for negotiating the logical channels between the service node SN VRBT and the called terminal UEB, which is performed in accordance with the ITU H.245 and ITU H.223 protocols, here incorporated for reference, begins after the sending, by the called terminal UEB, of the CONNECT message.

This method of setting up a video call according to the invention also presents the advantage of being compatible with a video to audio fallback procedure, in accordance with the SCUDIF standard. This is of interest in the case where the called terminal supports only audio, and is unable to support video.

Two embodiments are now described for the start of the negotiation step between the calling terminal UEA and the service node SN VRBT.

In a first preferred embodiment, the calling terminal UEA waits on the one hand to have received the ALERTING message from the local switch VMSC(A) and on the other hand to have detected an attempt to begin a negotiation of the logical channels on the part of the service node SN VRBT which alone has the initiative to begin the negotiation.

In a second embodiment, the calling terminal UEA, as soon as it has received the ALERTING message from the local switch VMSC(A), immediately begins the negotiation with the service node SN VRBT. In this case, the called terminal UEB must not, for its part, try to begin a negotiation of logical channels before having sent the CONNECT message, should a call forwarding mode in case there is no answer be activated. If, however, the called terminal UEB begins a negotiation of logical channels just after sending the ALERTING message, the service node SN VRBT must not respond immediately to this inquiry on behalf of the called terminal UEB, but rather wait to receive the ANM message, after sending the CONNECT message on behalf of the called terminal UEB if the latter answers or the CONNECT message on behalf of another service node if call forwarding arriving on the called terminal UEB is activated.

1. Method of setting up a video call between a calling terminal (UEA) and a called terminal (UEB), via a telecommunication network comprising a service node (SN) capable of providing a video application, comprising:
a call setup request step between the calling terminal and the called terminal;
an alert step indicating that the called terminal has been alerted;
a connection step indicating that the called terminal has answered;
a step for negotiating the setting up of video and audio logical channels between the calling terminal and the service node;
characterized in that the start of the negotiation step between the calling terminal and the service node is situated after the start of the alert step and before the start of the connection step.

2. Method of setting up a video call between a calling terminal and a called terminal according to claim 1, characterized in that the method also comprises a step for negotiating the setting up of video and audio logical channels between the called terminal and the service node.

3. Method of setting up a video call between a calling terminal and a called terminal according to claim 1, characterized in that the video application is a ringback tone with video function.

4. Method of setting up a video call between a calling terminal and a called terminal according to claim 1, characterized in that the start of the negotiation step is situated after the end of the alert step.

5. Method of setting up a video call between a calling terminal and a called terminal according to claim 1, characterized in that the telecommunication network is a third generation or subsequent generation circuit network.

6. Method of setting up a video call between a calling terminal and a called terminal according to claim 1, characterized in that:
the call setup request step extends between the transmission, by the calling terminal, of a call setup request message (SETUP), and the reception, by the called terminal, of a call setup request message (SETUP);
the alert step extends between the transmission, by the called terminal, of an alert message (ALERTING) indicating that the called terminal has been alerted, and the reception, by the calling terminal, of an alert message (ALERTING) indicating that the called terminal has been alerted;
the connection step extends between the transmission, by the called terminal, of a connection message (CONNECT) indicating that the called terminal has answered, and the reception, by the calling terminal, of a connection message (CONNECT) indicating that the called terminal has answered.

7. Method of setting up a video call between a calling terminal and a called terminal according to claim 1, characterized in that the negotiation step comprises on the one hand the setting up of a signaling channel and on the other hand the setting up of a multiplexing for the signaling channel and the video and audio logical channels.

8. Method of setting up a video call between a calling terminal and a called terminal according to claim 1, characterized in that:
said method conforms to the ITU H.324 protocol;
the call setup request step is a SETUP step;
the alert step is an ALERTING step;
the connection step is a CONNECT step;
the negotiation step conforms on the one hand to the ITU H.245 protocol for the setting up of a signaling channel and on the other hand to the ITU H.223 protocol for the setting up of a multiplexing for the signaling channel and the video and audio logical channels.

9. Calling terminal able:
to transmit a call setup request message (SETUP);
to receive an alert message (ALERTING) indicating that a called terminal has been alerted;
to receive a connection message (CONNECT) indicating that a called terminal has answered;
to negotiate with a service node capable of providing a video application on the one hand with the setting up of a signaling channel and on the other hand with the setting up of a multiplexing for the signaling channel and video and audio logical channels;
characterized in that said calling terminal comprises means for starting to negotiate after having received the alert message but before receiving the connection message.

10. Service node capable of providing a video application, able:
to transmit a message (IAM), the function of which is to transmit a call setup request message (SETUP) on behalf of a calling terminal;
to transmit a message (ACM), the function of which is to transmit an alert message (ALERTING) indicating that said called terminal has been alerted;
to transmit a message (ANM), the function of which is to transmit a connection message (CONNECT) indicating that said called terminal has answered;
to negotiate with a calling terminal on the one hand on the setting up of a signaling channel and on the other hand on the setting up of a multiplexing for the signaling channel and video and audio logical channels;
characterized in that said service node comprises means for starting to negotiate after having transmitted the alert message but before having transmitted the connection message.
